(19) United States
(12) Patent Application Publication
(10) Pub. No.: US 2025/0390451 A1
(43) Pub. Date: Dec. 25, 2025

(54) SYSTEMS AND METHODS FOR MITIGATING LATENCY IN INPUT/OUTPUT TRANSACTIONS

(71) Applicant: Netflix, Inc., Los Gatos, CA (US)

(72) Inventor: Michael Warner Losh, III, Brighton, CO (US)

(21) Appl. No.: 19/215,719

(22) Filed: May 22, 2025

Related U.S. Application Data
(60) Provisional application No. 63/663,993, filed on Jun. 25, 2024.

(51) Int. Cl. G06F 13/20

(52) U.S. Cl. CPC G06F 13/20; G06F 2213/40

(57) ABSTRACT

A system for mitigating latency in I/O transactions may include and/or represent a storage device configured to store data at logical block addresses (LBAs) and circuitry configured to monitor the latency of I/O transactions performed on the storage device. In one example, the circuitry may be configured to detect a latency of an I/O transaction performed on a portion of the data stored at one of the LBAs. In this example, the circuitry may be further configured to determine that the latency of the I/O transaction exceeds a certain threshold and then perform a remedial action in connection with the portion of data in response to determining that the latency exceeds the certain threshold. Various other methods, systems, and computer-readable media are also disclosed.

### CROSS REFERENCE TO RELATED APPLICATION

This application claims the benefit of U.S. Provisional Application No. 63/663,993 filed Jun. 25, 2024, the disclosure of which is incorporated in its entirety by this reference.

### BACKGROUND

In modern computing environments, storage systems often facilitate the storage, retrieval, and/or streaming of data. Storage systems access such data via Input/output (I/O) transactions, such as read and/or write operations. Unfortunately, storage systems may experience latency issues that degrade the performance of I/O transactions. These latency issues often lead to and/or cause degraded quality of experience (QoE) for users and/or inefficient data management. The instant disclosure, therefore, identifies and addresses a need for systems and methods for monitoring and/or mitigating excessive latency in I/O transactions.

### SUMMARY

As will be described in greater detail below, the present disclosure describes systems and methods for mitigating latency in input/output (I/O) transactions performed on storage devices. In some examples, a system includes and/or represents a storage device configured to store data at logical block addresses (LBAs) and circuitry configured to monitor the latency of I/O transactions performed on the storage device. In one example, the circuitry is configured to detect a latency of an I/O transaction performed on a portion of the data stored at one of the LBAs. In this example, the circuitry is further configured to determine that the latency of the I/O transaction exceeds a certain threshold and then perform a remedial action in connection with the portion of data in response to determining that the latency exceeds the certain threshold.

In some examples, the circuitry is configured to perform the remedial action by rewriting the portion of data to another one of the LBAs. Additionally or alternatively, the circuitry is configured to free a memory block of the storage device at the one of the LBAs by rewriting the portion of data. In one example, the circuitry is configured to recharge the freed memory block at the one of the LBAs to prepare the freed memory block for reallocation.

In some examples, the circuitry is configured to perform the remedial action by (1) identifying a file to which the portion of data belongs, (2) identifying an additional portion of the data that belongs to the file and is stored at an additional one of the LBAs, and then (3) rewriting the additional portion of data to the additional one of the LBAs or to another one of the LBAs. Additionally or alternatively, the circuitry is configured to identify the file by identifying metadata in a file system corresponding to the storage device and then determining that the portion of data belongs to the file based at least in part on the metadata.

In some examples, the circuitry is configured to perform the remedial action by rewriting the portion of data to the one of the LBAs. In one example, the circuitry is configured to monitor latencies of I/O transactions performed on the data stored at the LBAs and then dynamically set the certain threshold based at least in part on the latencies of the I/O transactions. Additionally or alternatively, the circuitry is configured to set the certain threshold to represent a permissible amount of time to complete I/O transactions.

In some examples, the storage device includes and/or represents at least one of a flash memory device or a hard disk drive. In one example, the I/O transaction includes and/or represents a read operation and/or a write operation.

In some examples, a computer-implemented method for mitigating latency in I/O transactions involves storing data at LBAs of a storage device and/or detecting a latency of an I/O transaction performed on a portion of the data stored at one of the LBAs. In one example, the computer-implemented method also involves determining that the latency exceeds a certain threshold and then performing a remedial action in connection with the portion of data in response to determining that the latency exceeds the certain threshold.

In some examples, a non-transitory computer-readable medium comprises one or more computer-executable instructions that, when executed by circuitry of a computing device, cause the circuitry to store data at LBAs of a storage device and/or detect a latency of an I/O transaction performed on a portion of the data stored at one of the LBAs. In one example, such instructions, when executed by the circuitry, further cause the circuitry to determine that the latency exceeds a certain threshold and then perform a remedial action in connection with the portion of data in response to determining that the latency exceeds the certain threshold.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary computing device and storage configuration for mitigating latency in I/O transactions in accordance with one or more implementations of this disclosure.

FIG. 2 illustrates an exemplary system for mitigating latency in I/O transactions in accordance with one or more implementations of this disclosure.

FIG. 3 illustrates an exemplary storage device configured to facilitate mitigating latency in I/O transactions in accordance with one or more implementations of this disclosure.

FIG. 4 illustrates an exemplary method for mitigating latency in I/O transactions in accordance with one or more implementations of this disclosure.

FIG. 5 illustrates a block diagram of an exemplary content distribution ecosystem.

FIG. 6 illustrates a block diagram of an exemplary distribution infrastructure within the content distribution ecosystem shown in FIG. 5.

FIG. 7 illustrates a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for mitigating latency in input/output (I/O) transactions. As will be explained in greater detail below, these systems and methods provide numerous features and benefits.

In some examples, latency refers to and/or represents the delay between the initiation and completion of an I/O transaction. Various factors may contribute to increased latency, including hardware deficiencies like varying and/or degrading voltage levels in flash memory cells and/or incomplete writes in spinning disk drives.

In some examples, a system includes and/or represents one or more storage devices that store data that constitute computer files. In one example, a computing device directs and/or causes the storage devices to read file data from and/or write file data to certain logical block addresses (LBAs). Some of these LBAs in the storage devices exhibit, experience, and/or impart a certain amount of latency on I/O transactions (e.g., read and/or write operations). For example, an I/O transaction performed at one LBA in a storage device may take significantly longer than a similar and/or identical I/O transaction performed at another LBA in the storage device.

In some examples, the latency disparity between these I/O transactions stems and/or results from different causes and/or deficiencies in the hardware and/or architecture of the storage devices (e.g., varying and/or degrading voltage or charge levels of cells in flash memory, incomplete and/or partial writes to tracks in spinning disk drives, etc.). In one example, the computing device and/or storage devices track, monitor, and/or measure the latencies of I/O transactions performed on the LBAs in the storage devices. In this example, the computing device and/or storage devices identify and/or detect which LBAs produce and/or cause latencies that exceed a certain threshold in connection with those I/O transactions.

In some examples, the computing device and/or storage devices take and/or perform certain steps and/or actions to remedy and/or mitigate those excessive latencies. For example, the computing device and/or storage devices rewrite the file data stored at an LBA that produced and/or caused excessive latency in connection with an I/O transaction. In this example, by rewriting the file data, the computing device and/or storage devices effectively free and/or vacate the memory block at that LBA. In one example, the computing device and/or storage devices move the file data by rewriting the file data to a different LBA that produces and/or causes less latency than the previous LBA.

In some examples, the storage devices refresh, rehabilitate, and/or recharge the freed and/or vacated memory blocks at the slow LBA. In one example, by doing so, the storage devices prepare the memory block at the slow LBA for reallocation and/or storage of new data and/or content. As a result, the storage devices improve and/or mitigate the latency of the memory block at the previously slow LBA.

Features from any of the implementations described herein are used in combination with one another in accordance with the general principles described herein. These and other implementations, features, and advantages are more fully understood upon reading the following detailed description in conjunction with the accompanying drawings and claims.

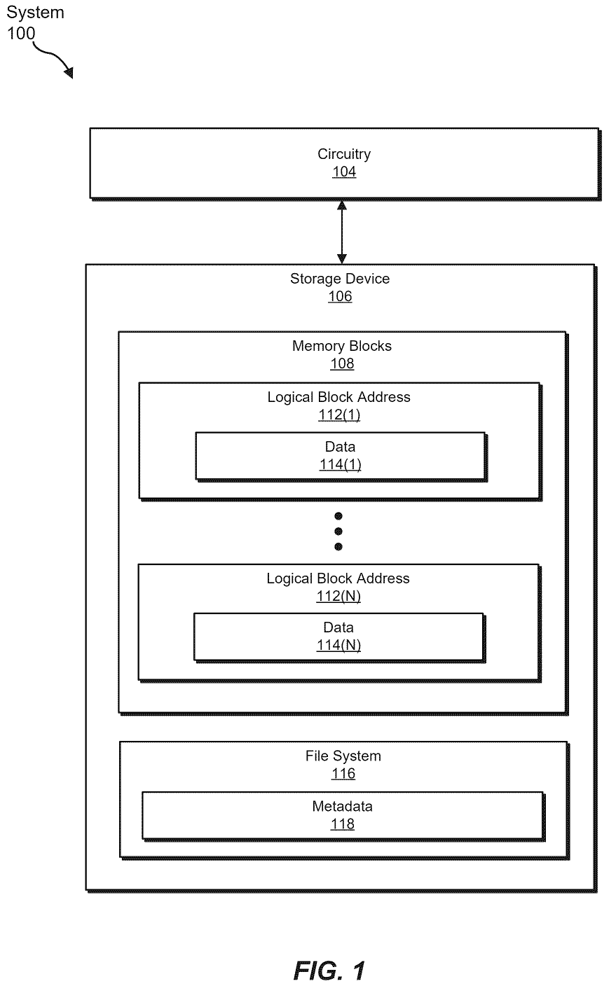

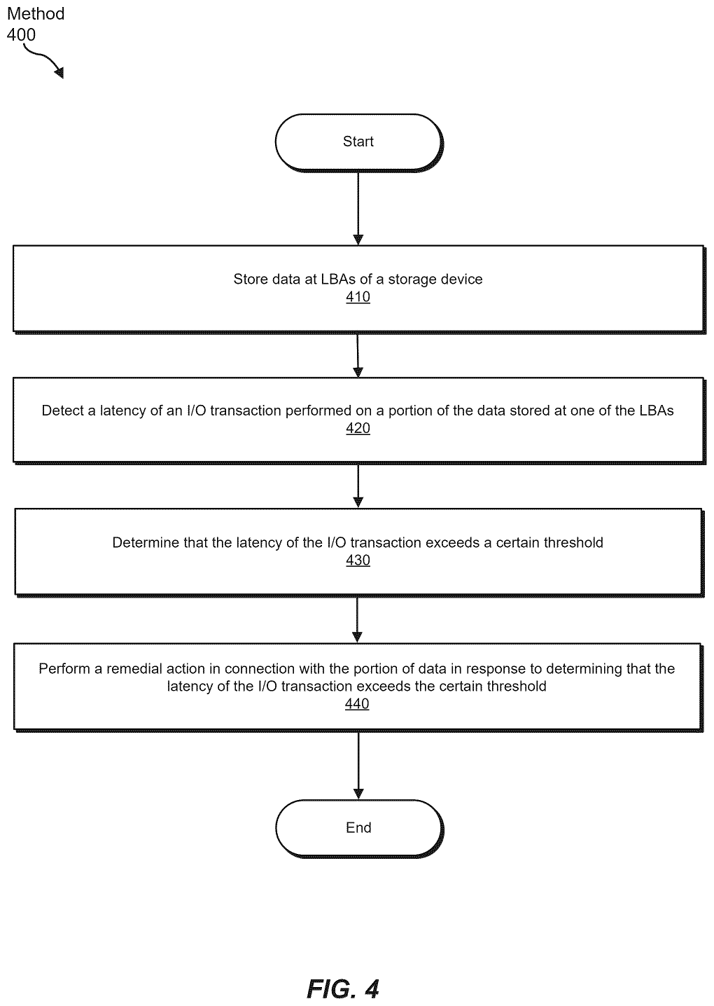

The following will provide, with reference to FIGS. 1-3 and 5-7, detailed descriptions of exemplary devices, systems, and corresponding implementations or configurations that facilitate and/or support mitigating latency in I/O transactions. The following will also provide, with reference to FIG. 4, examples of methods for mitigating latency in I/O transactions.

FIG. 1 illustrates an exemplary system 100 capable of mitigating latency in input/output (I/O) transactions performed on storage device 106. In some examples, system 100 includes and/or represents circuitry 104 that interfaces with and/or is communicatively coupled to storage device 106. In one example, storage device 106 stores, maintains, and/or manages data at logical block addresses (LBAs) 112(1)-(N). In certain implementations, each of LBAs 112(1)-(N) corresponds and/or is assigned to one of memory blocks 108 within storage device 106.

In some examples, storage device 106 stores and/or maintains data 114(1)-(N) in LBAs 112(1)-(N), respectively. In one example, data 114(1)-(N) includes and/or represents portions of computer files stored in storage device 106.

In certain implementations, system 100 is contained and/or housed in a single standalone device. In other implementations, system 100 is distributed across multiple computing devices that are communicatively coupled to one another (e.g., via a network). For example, circuitry 104 is included in one computing device, while storage device 106 is included in another computing device, such as a server. In one example, some or all of circuitry 104 is integrated into and/or represents part of storage device 106. Additionally or alternatively, some or all of circuitry 104 constitutes and/or represents one or more standalone or separate circuits that are communicatively coupled to storage device 106.

In some examples, circuitry 104 monitors, measures, determines, and/or detects the latency of I/O transactions, such as read or write operations, performed on data 114(1)-(N) stored at LBAs 112(1)-(N) of storage device 106. In one example, circuitry 104 compares the latencies of such I/O transactions against a certain threshold. In this example, circuitry 104 determines that the latency of one of the I/O transactions exceeds that threshold. For example, a read or write operation performed on data 114(1) and/or LBA 112(1) takes an impermissible and/or unacceptable amount of time to complete.

In some examples, circuitry 104 dynamically sets and/or defines the threshold based at least in part on the latencies of the I/O transactions. For example, circuitry 104 adjusts the threshold for permissible and/or acceptable latency based on some or all of the monitored I/O transactions. In this example, circuitry 104 identifies the latency that falls within a certain percentage of the slowest I/O transactions (e.g., the latencies that fall within the slowest 5%, 10%, 15%, 20%, etc., of all the I/O transactions). Circuitry 104 then applies that latency as the threshold for the permissible and/or acceptable amount of time to complete I/O transactions.

In some examples, in response to detecting the latency of the I/O transaction that exceeds the threshold, circuitry 104 performs, implements, and/or executes a remedial action in connection with the data involved in the I/O transaction. For example, circuitry 104 performs a remedial action on data 114(1) and/or LBA 112(1) due at least in part to a read or write operation directed to data 114(1) and/or LBA 112(1) taking an impermissible and/or unacceptable amount of time to complete.

Various remedial actions may be applied and/or implemented to address, mitigate, and/or reduce latencies in slow LBAs. As one example, circuitry 104 rewrites data 114(1) from LBA 112(1) to another LBA that is less prone to latency issues. In this example, by rewriting data 114(1) to another LBA, circuitry 104 frees the memory block assigned LBA 112(1) for reallocation and also optimizes the performance of future I/O transactions. Additionally or alternatively, circuitry 104 electrically recharges and/or rehabilitates the freed memory block at LBA 112(1) to prepare the same for reallocation and/or improved performance. By doing so, circuitry 104 ensures that the memory block is conditioned electrically for new data.

As one example, circuitry 104 rewrites data 114(1) to LBA 112(1) after rehabilitating LBA 112(1). In this example, circuitry 104 temporarily stores a copy of data 114(1) in another location to free up the underlying memory block assigned LBA 112(1) for rehabilitation. Circuitry 104 then recharges and/or reconditions the underlying memory block to support higher and/or more stable cell voltages. Finally, circuitry 104 rewrites data 114(1) to the recharged and/or reconditioned version of the memory block assigned LBA 112(1).

As another example, circuitry 104 identifies a file to which data 114(1) belongs and then rewrites additional portions of data incorporated in the file to other LBAs. In this example, by rewriting those additional portions of data in this way, circuitry 104 improves data storage optimization and/or performance by ensuring that all the file data is stored in LBAs with better latency characteristics.

As a further example, circuitry 104 performs and/or implements proactive data movement to prevent further degradation of latency performance. For example, in scenarios involving read-disturb effects in NAND memory, circuitry 104 moves data from LBAs showing initial signs of latency issues. Additionally or alternatively, circuitry 104 logs and/or records errors and/or latency data for offline analysis to spot trends for informing future remedial actions.

As an additional example, circuitry 104 performs and/or implements drive-specific error handling through scripts that make remedial-action decisions based at least in part on the specific characteristics of storage device 106. In one example, such remedial-action decisions involve retiring a disk model from service, removing files with read errors, and/or reindexing storage device 106.

In one example, if storage device 106 includes a spinning drive, circuitry 104 rewrites data 112(1) to refresh LBA 114(1) and/or the underlying memory block to facilitate more accurate and/or efficient read operations. In this example, inaccurate and/or inefficient read operations result from and/or are caused by imperfections in the preceding write operation. By rewriting data 112(1) in this way, circuitry 104 restores data 112(1) to the intended content and/or proper specifications.

In some examples, system 100 utilizes, inspects, and/or leverages metadata 118 of file system 116 to identify all file data associated with a file impaired by a slow LBA. In one example, metadata 118 serves as a comprehensive index of information about the files stored in storage device 106, including details such as file names, sizes, types, and the specific LBAs where portions of the file data are located. Upon detecting latency issues at a particular LBA, circuitry 104 accesses metadata 118 to determine which file is affected by the slow LBA. By analyzing metadata 118, circuitry 104 identifies all related portions of the file data that are distributed across various LBAs. By doing so, circuitry 104 is able to perform remedial actions, such as rewriting the affected file data to alternative LBAs with better performance characteristics, thereby optimizing and/or improving data storage and access. Accordingly, circuitry 104 enhances the reliability and/or efficiency of data management by proactively moving file to new LBAs that exhibit improved latency and/or I/O performance.

In some examples, storage device 106 includes and/or represents any type or form of volatile or non-volatile storage device or medium capable of storing data, computer-readable instructions, and/or load-balancing options. In one example, storage device 106 maintains and/or stores one or more computer-readable instructions, modules, programs, applications, and/or load-balancing options 130(1)-(N). Examples of storage device 106 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable memory.

In some examples, circuitry 104 includes and/or represents one or more electrical and/or electronic circuits capable of processing, applying, modifying, transforming, displaying, transmitting, receiving, and/or executing data for system 100. In one example, circuitry 104 accesses and/or analyzes data stored in storage device 106 to facilitate and/or support mitigating latency in I/O transactions. Additionally or alternatively, circuitry 104 launches, performs, and/or executes certain executable files, code snippets, and/or computer-readable instructions to facilitate and/or support mitigating latency in I/O transactions.

Although illustrated as a single unit in FIG. 1, circuitry 104 includes and/or represents a collection of multiple processing units and/or electrical or electronic components that work and/or operate in conjunction with one another. Examples of circuitry 104 include, without limitation, processing devices, hardware processors, microprocessors, microcontrollers, field-programmable gate arrays (FPGAs), application-specific integrated circuits (ASICs), graphics processing units (GPUs), central processing units (CPUs), systems on chips (SoCs), parallel accelerated processors, tensor cores, integrated circuits, chiplets, optical modules, receivers, transmitters, transceivers, storage devices, memory devices, digital logic, analog circuitry, digital circuitry, portions of one or more of the same, variations or combinations of one or more of the same, and/or any other suitable circuitry.

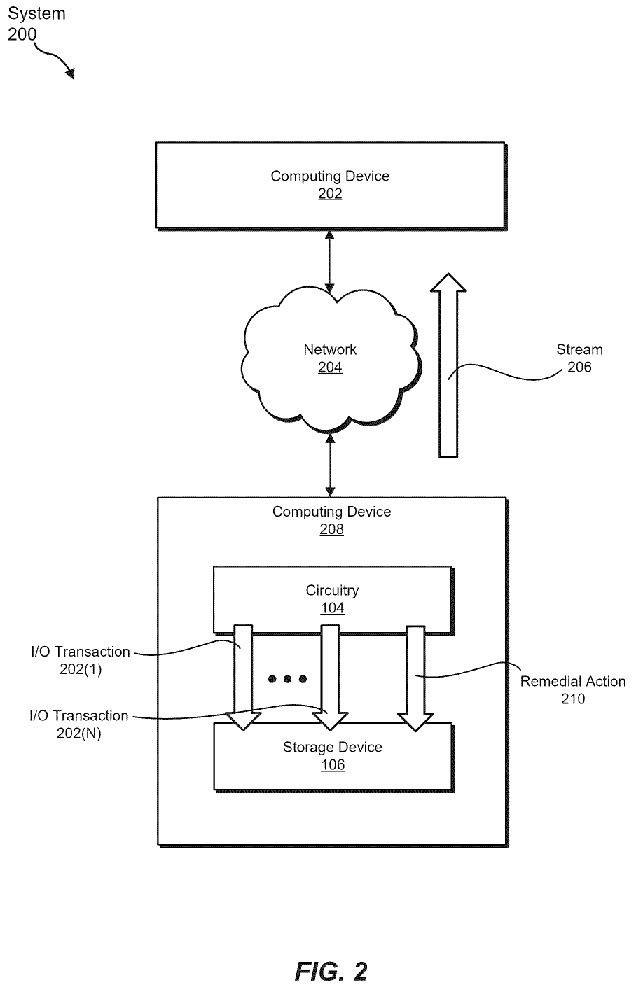

FIG. 2 illustrates an exemplary system 200 that facilitates and/or supports mitigating latency in I/O transactions. In some examples, system 200 in FIG. 2 includes and/or involves certain devices, components, configurations, and/or features that perform and/or provide functionalities that are similar and/or identical to those described above in connection with FIG. 1. In one example, system 200 includes and/or represents computing devices 202 and 208 communicatively coupled to one another via a network 204. In this example, computing device 208 includes and/or represents circuitry 104 and/or storage device 106. Alternatively, although not necessarily illustrated in this way in FIG. 2, circuitry 104 is included in and/or implemented on a remote device that is communicatively coupled to computing device 208 via network 204.

In this example, circuitry 104 monitors, measures, determines, and/or detects the latency of I/O transactions 202(1)-(N) performed on data stored at LBAs of storage device 106. In one example, circuitry 104 compares the latencies of I/O transactions 202(1)-(N) against a certain threshold. In this example, circuitry 104 determines that the latency of I/O transaction 202(N) exceeds that threshold. For example, a read or write operation performed on one of the LBAs on storage device 106 takes an impermissible, excessive, and/or unacceptable amount of time to complete.

In some examples, in response to determining that the latency of I/O transaction 202(N) exceeds the threshold, circuitry 104 performs, implements, and/or executes a remedial action 210 in connection with the LBA involved in I/O transaction 202(N). For example, circuitry 104 rewrites the data stored at the LBA involved in I/O transaction 202(N) due at least in part to I/O transaction 202(N) taking an impermissible and/or unacceptable amount of time to complete. In one example, remedial action 210 involves rewriting the file data stored at that LBA to another LBA with better latency characteristics.

In the context of FIG. 2, computing device 208 transmits and/or provides a stream 206 of data (e.g., video, audio, and/or gaming data) to computing device 202 via network 204. In some examples, computing device 202 serves as a source or destination for data streams, depending on the specific application or configuration. Similarly, computing device 208 functions as the counterpart, either receiving or sending data streams. The data streaming process involves the continuous flow of data packets that are transmitted over network 204.

In some examples, stream 206 constitutes and/or represents the logical pathway through which data packets travel between computing device 202 and computing device 208. In one example, network 204 constitutes and/or represents any medium or architecture capable of facilitating communication or data transfer. In this example, network 204 facilitates communication between computing device 202 and/or computing device 208. For example, network 204 facilitates and/or supports this communication via one or more intermediate nodes (e.g., hops) between computing device 202 and/or computing device 208. These intermediate nodes include and/or represent any type or form of suitable network device.

In some examples, network 204 facilitates and/or supports communication or data transfer using wireless and/or wired connections. In one example, network 204 includes and/or represents all or a portion of the Internet. Additional examples of network 204 include, without limitation, an intranet, a Wide Area Network (WAN), a Local Area Network (LAN), a Personal Area Network (PAN), Power Line Communications (PLC), a cellular network (e.g., a Global System for Mobile Communications (GSM) network), an multiprotocol label switching (MPLS) network, portions of one or more of the same, variations or combinations of one or more of the same, and/or any other suitable network.

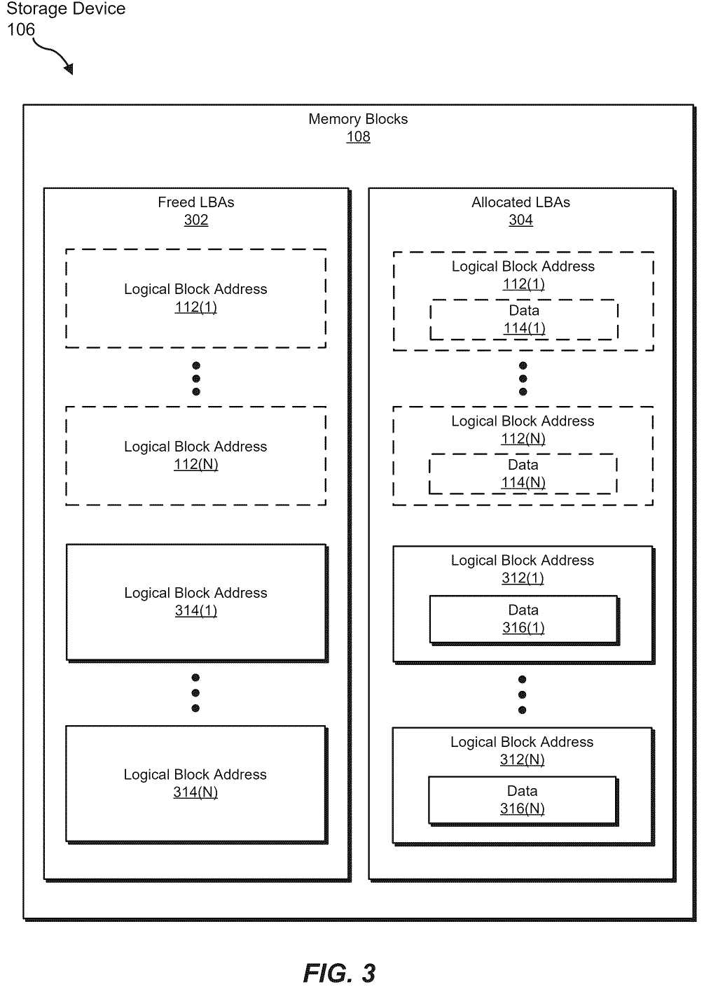

FIG. 3 illustrates an exemplary storage device 106 configured to manage data stored at LBAs assigned to memory blocks 108. In some examples, storage device 106 in FIG. 3 includes and/or involves certain devices, components, configurations, and/or features that perform and/or provide functionalities that are similar and/or identical to those described above in connection with either FIG. 1 or FIG. 2. In one example, storage device 106 includes and/or represents freed LBAs 302 and/or allocated LBAs 304. In this example, freed LBAs 302 include and/or represent a pool of memory blocks that have been released, freed, and/or vacated for reallocation. Additionally or alternatively, allocated LBAs 304 include and/or represent memory blocks that have been allocated and/or provided for storage of file data.

In some examples, allocated LBAs 304 include and/or represent LBAs 112(1)-(N) that have been allocated and/or provided to store data 114(1)-(N), respectively. Additionally or alternatively, allocated LBAs 304 include and/or represent LBAs 312(1)-(N) that have been allocated and/or provided to store data 316(1)-(N), respectively. In one example, circuitry 104 monitors, measures, determines, and/or detects the latency of I/O transactions performed at LBAs allocated LBAs 304 of storage device 106. In this example, circuitry 104 compares the latencies of such I/O transactions against a certain threshold. In certain scenarios, circuitry 104 determines that the latency of one or more of these I/O transactions exceeds the threshold.

In some examples, in response to determining that the latency of an I/O transaction exceeds the threshold, circuitry 104 performs, implements, and/or executes a remedial action in connection with the LBA involved in that I/O transaction. For example, circuitry 104 rewrites data 114(1)-(N) stored at LBAs 112(1)-(N) to other LBAs with better latency characteristics. In one example, by doing so, circuitry 104 releases and/or frees LBAs 112(1)-(N) for recharging and/or reconditioning before LBAs 112(1)-(N) are reallocated. Accordingly, freed LBAs 302 temporarily include and/or represent LBAs 112(1)-(N) and/or LBAs 314(1)-(N) at a certain moment in time. After being recharged and/or reconditioned, LBAs 112(1)-(N) exhibit and/or provide better latency characteristics in connection with subsequent I/O transactions.

As described above in connection with FIGS. 1-3, these systems and methods are directed to managing and/or mitigating latency in data storage systems, particularly focusing on LBAs that exhibit elevated latency. One approach involves monitoring I/O operations that exceed a predefined and/or dynamic latency threshold and then reporting the affected LBAs through a standard mechanism in the underlying operating system (e.g., FreeBSD). Such proactive monitoring facilitates and/or supports the identification of underperforming and/or defective memory blocks that contribute to latency issues.

Upon identifying LBAs with elevated latency, the system takes corrective action by rewriting the affected files. This rewriting process effectively frees the problematic memory blocks, ensuring that their use is temporarily suspended to prevent further latency degradation. For non-volatile memory express (NVMe) drives, this remedial action may result in the allocation of a different chunk of NAND memory, mitigating issues such as read-disturb effects. These effects occur when frequently accessed content causes charge accumulation in NAND cells, potentially altering the data. By moving data proactively, the system addresses latency issues in advance to avoid excessive wear on the drive that might otherwise result from a static approach.

For large spinning drives such as 10TB and 12TB models, the system addresses vendor-reported issues where tracks have not been written accurately. Such inaccurately written tracks result in LBAs that impair corresponding read operations. By rewriting the data, the system restores such tracks to the normal and/or intended specifications, limiting the window of performance degradation visible to users and/or enhancing the quality of experience (QoE).

In some examples, the system employs various components to implement these strategies. For instance, FreeBSD publishes events related to errors detected in NVMe devices, small computer system interface (SCSI) devices, and/or advanced technology attachment (ATA) devices. In one example, the common access method (CAM) layer and/or its I/O scheduler provide high latency measurements, which are then used by scripts running in response to these events. These scripts make drive-specific decisions, logging detailed error information for offline analysis and/or trend identification. This data-driven approach informs future remediation actions to ensure timely and effective latency management.

In some examples, if low-latency remediation is required, the system retires certain disk models and/or removes files with read errors. To support retiring such disk models and/or removal of files, the system reindexes the corresponding data as necessary. The system also considers whether certain I/O errors are clustered around specific memory blocks, which often indicates issues with and/or defects in the write head. By analyzing these patterns, the system makes informed decisions about retiring components and/or reallocating resources.

In some examples, the system includes and/or implements a charging feature for freed memory blocks. For example, once an LBA is vacated, the system recharges the LBA electrically to prepare the same for future use. In this example, by doing so, the system ensures that the LBA is restored to its optimal condition for storing new data. This recharging process enhances the overall performance and reliability of the storage system. Accordingly, the system provides a comprehensive framework for managing latency in data storage, implementing proactive data rewrites, and/or strategic error handling to enhance overall performance and reliability.

In some examples, the various systems, components, and/or features described in connection with FIGS. 1-3 may include and/or represent one or more additional circuits, components, and/or features that are not necessarily illustrated and/or labeled in FIGS. 1-3. For example, the systems, components, and/or features illustrated in FIGS. 1-3 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, combinations or variations of one or more of the same, and/or any other suitable components. In certain implementations, one or more of these additional circuits, components, and/or features may be inserted and/or applied between any of the existing circuits, components, and/or features illustrated in FIGS. 1-3 consistent with the aims and/or objectives described herein. Accordingly, the couplings and/or connections described with reference to FIGS. 1-3 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In one example, the indirect coupling may include and/or incorporate at least one additional computing device between two computing devices illustrated in any of FIGS. 1-3. In some implementations, one or more components and/or devices illustrated in FIGS. 1-3 may be omitted and/or excluded from the corresponding systems.

FIG. 4 is a flow diagram of an exemplary computer-implemented method 400 for mitigating latency in I/O transactions. In one example, the steps shown in FIG. 4 are performed by circuitry incorporated and/or implemented in one or more computing devices. Additionally or alternatively, the steps shown in FIG. 4 incorporate and/or involve certain sub-steps and/or variations consistent with the descriptions provided above in connection with FIGS. 1-3.

As illustrated in FIG. 4, method 400 includes and/or involves the step of storing data at LBAs of a storage device (410). Step 410 is performed in a variety of ways, including any of those described above in connection with FIGS. 1-3. For example, circuitry stores data at LBAs of a storage device.

Method 400 also includes and/or involves the step of detecting a latency of an I/O transaction performed on a portion of the data stored at one of the LBAs (420). Step 420 is performed in a variety of ways, including any of those described above in connection with FIGS. 1-3. For example, the circuitry detects a latency of an I/O transaction performed on a portion of the data stored at one of the LBAs.

Method 400 further includes and/or involves the step of determining that the latency of the I/O transaction exceeds a certain threshold (430). Step 430 is performed in a variety of ways, including any of those described above in connection with FIGS. 1-3. For example, the circuitry determines that the latency of the I/O transaction exceeds a certain threshold.

Method 400 further includes and/or involves the step of performing a remedial action in connection with the portion of data in response to determining that the latency of the I/O transaction exceeds the certain threshold (440). Step 440 is performed in a variety of ways, including any of those described above in connection with FIGS. 1-3. For example, the circuitry performs a remedial action in connection with the portion of data in response to determining that the latency of the I/O transaction exceeds the certain threshold.

Furthermore, a corresponding non-transitory computer-readable medium is provided that includes one or more computer-executable instructions that, when executed by at least one processor of a computing device, cause the computing device to store data at LBAs of a storage device and/or detect a latency of an I/O transaction performed on a portion of the data stored at one of the LBAs. In one example, such instructions, when executed by the circuitry, may further cause the circuitry to determine that the latency exceeds a certain threshold and then perform a remedial action in connection with the portion of data in response to determining that the latency exceeds the certain threshold.

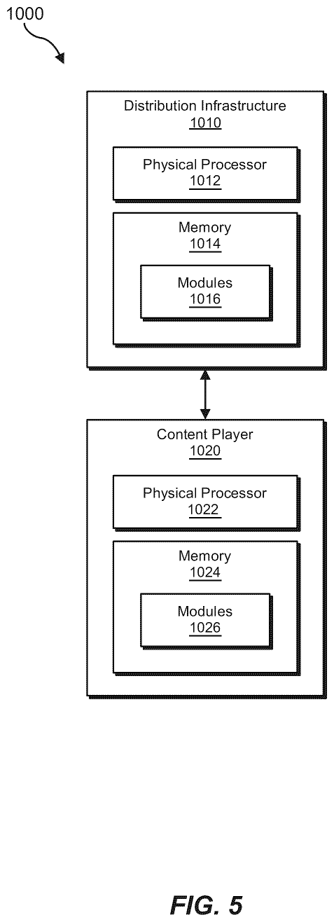

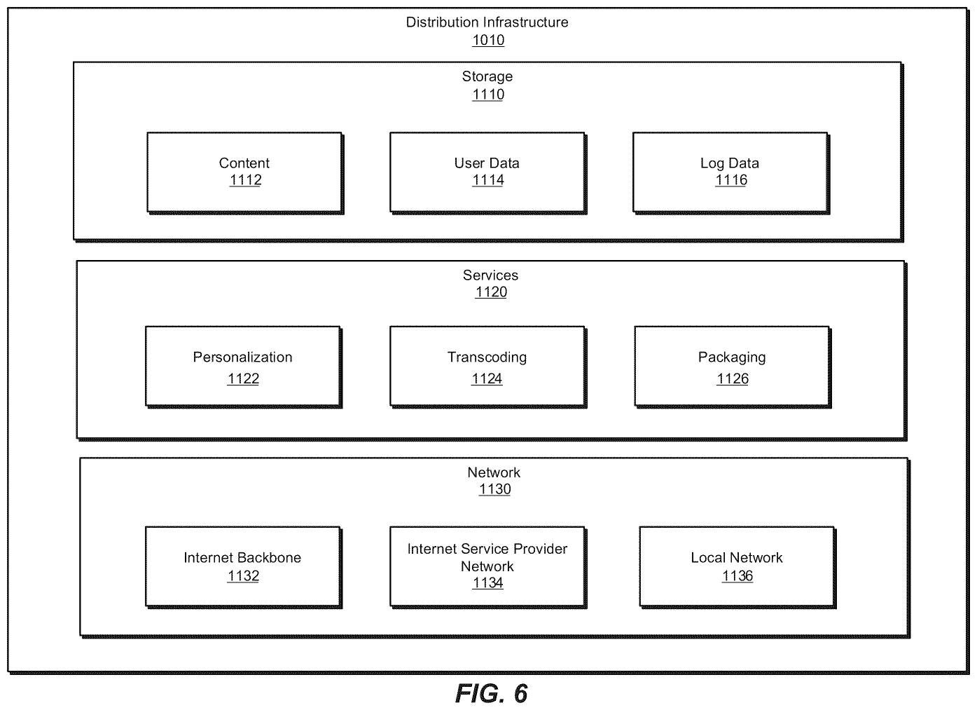

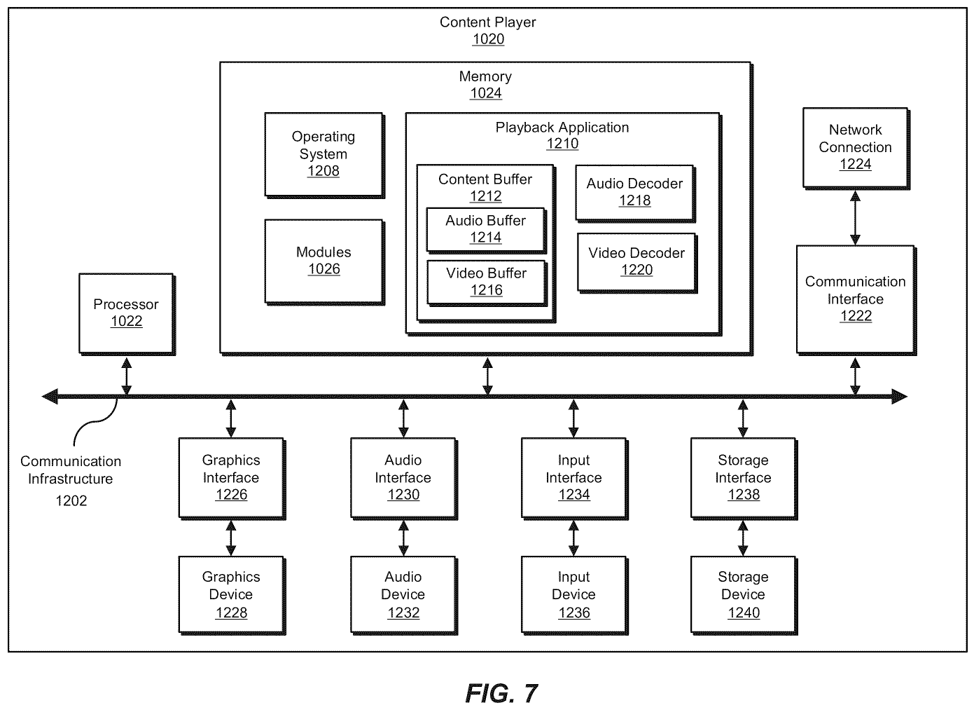

The following will provide, with reference to FIG. 5, detailed descriptions of exemplary ecosystems in which content is provisioned to end nodes and in which requests for content are steered to specific end nodes. The discussion corresponding to FIGS. 6 and 7 presents an overview of an exemplary distribution infrastructure and an exemplary content player used during playback sessions, respectively. These exemplary ecosystems and distribution infrastructures are implemented in any of the embodiments described above with reference to FIGS. 1-4.

FIG. 5 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 5 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 5 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 6 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Encoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 6, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 7 is a block diagram of an exemplary implementation of content player 1020 of FIG. 5. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 7, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 7, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 7 need not be present to practice the embodiments described and/or illustrated herein. The devices and subsystems referenced above are also interconnected in different ways from that shown in FIG. 7. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a storage device configured to store data at logical block addresses (LBAs); and circuitry configured to:
detect a latency of an input/output (I/O) transaction performed on a portion of the data stored at one of the LBAs;
determine that the latency of the I/O transaction exceeds a certain threshold; and
perform a remedial action in connection with the portion of data in response to determining that the latency of the I/O transaction exceeds the certain threshold.

2. The system of claim 1, wherein the circuitry is further configured to perform the remedial action by rewriting the portion of data to another one of the LBAs.

3. The system of claim 2, wherein the circuitry is further configured to free a memory block of the storage device at the one of the LBAs by rewriting the portion of data.

4. The system of claim 3, wherein the circuitry is further configured to recharge the freed memory block at the one of the LBAs to prepare the freed memory block for reallocation.

5. The system of claim 2, wherein the circuitry is further configured to perform the remedial action by:
identifying a file to which the portion of data belongs;
identifying an additional portion of the data that belongs to the file and is stored at an additional one of the LBAs; and
rewriting the additional portion of data to the additional one of the LBAs or to another one of the LBAs.

6. The system of claim 5, wherein the circuitry is further configured to identify the file by:
identifying metadata in a file system corresponding to the storage device; and
determining that the portion of data belongs to the file based at least in part on the metadata.

7. The system of claim 1, wherein the circuitry is further configured to perform the remedial action by rewriting the portion of data to the one of the LBAs.

8. The system of claim 1, wherein the circuitry is further configured to:
monitor latencies of I/O transactions performed on the data stored at the LBAs; and
dynamically set the certain threshold based at least in part on the latencies of the I/O transactions.

9. The system of claim 1, wherein the circuitry is further configured to set the certain threshold to represent a permissible amount of time to complete I/O transactions.

10. The system of claim 1, wherein the storage device comprises at least one of:
a flash memory device; or
a hard disk drive.

11. The system of claim 1, wherein the I/O transaction comprises at least one of:
a read operation; or
a write operation.

12. A computer-implemented method comprising:
storing data at logical block addresses (LBAs) of a storage device;
detecting a latency of an input/output (I/O) transaction performed on a portion of the data stored at one of the LBAs;
determining that the latency of the I/O transaction exceeds a certain threshold; and
performing a remedial action in connection with the portion of data in response to determining that the latency of the I/O transaction exceeds the certain threshold.

13. The computer-implemented method of claim 12, wherein performing the remedial action comprises rewriting the portion of data to another one of the LBAs.

14. The computer-implemented method of claim 13, wherein rewriting the portion of data comprises freeing a memory block of the storage device at the one of the LBAs.

15. The computer-implemented method of claim 14, wherein rewriting the portion of data comprises recharging the freed memory block at the one of the LBAs to prepare the freed memory block for reallocation.

16. The computer-implemented method of claim 13, wherein performing the remedial action comprises:
identifying a file to which the portion of data belongs;
identifying an additional portion of the data that belongs to the file and is stored at an additional one of the LBAs; and
rewriting the additional portion of data to the additional one of the LBAs or to another one of the LBAs.

17. The computer-implemented method of claim 16, wherein identifying the file comprises:
identifying metadata in a file system corresponding to the storage device; and
determining that the portion of data belongs to the file based at least in part on the metadata.

18. The computer-implemented method of claim 12, wherein performing the remedial action comprises rewriting the portion of data to the one of the LBAs.

19. The computer-implemented method of claim 12, further comprising:
monitoring latencies of I/O transactions performed on the data stored at the LBAs; and
dynamically setting the certain threshold based at least in part on the latencies of the I/O transactions.

20. A non-transitory computer-readable medium comprising one or more computer-executable instructions that, when executed by circuitry of a computing device, cause the circuitry to:
store data at logical block addresses (LBAs) of a storage device;
detect a latency of an input/output (I/O) transaction performed on a portion of the data stored at one of the LBAs;
determine that the latency of the I/O transaction exceeds a certain threshold; and
perform a remedial action in connection with the portion of data in response to determining that the latency of the I/O transaction exceeds the certain threshold.
